(19) United States
(12) Patent Application Publication
(10) Pub. No.: US 2025/0372606 A1
(43) Pub. Date: Dec. 4, 2025

(54) ELECTRODE SHEET MANUFACTURING APPARATUS, ELECTRODE SHEET MANUFACTURING METHOD, AND METHOD OF MANUFACTURING BATTERY

(71) Applicant: Prime Planet Energy & Solutions, Inc., Tokyo (JP)

(72) Inventors: Tetsumasa MARUO, Ibaraki-shi (JP); Shinji YOSHIOKA, Himeji-shi (JP); Shota HIROHATA, Kasai-shi (JP); Toshiatsu ODAI, Himeji-shi (JP); Daichi UMINO, Himeji-shi (JP); Yuuki TOYOSHIMA, Himeji-shi (JP); Hiroyoshi YAMAMOTO, Himeji-shi (JP)

(21) Appl. No.: 19/216,711

(22) Filed: May 23, 2025

(30) Foreign Application Priority Data
May 28, 2024 (JP) 2024-086693

(51) Int. Cl. H01M 4/04; H01M 4/66; H01M 10/04

(52) U.S. Cl. CPC H01M 4/0435; H01M 4/661; H01M 10/0468

(57) ABSTRACT

A method of method of manufacturing an electrode sheet includes: a first pressing step of press-stretching an uncoated portion of the electrode sheet by a rubber roll while conveying the electrode sheet along a predetermined conveyance passage, a stepped roll pressing step of, after the first pressing step, conveying the electrode sheet while pressing the electrode sheet onto a stepped roll including a stepped portion at a part of the stepped roll coming into contact with a boundary region of the uncoated portion with an active material layer, the part coming into contact with the unformed portion having a larger diameter than other parts of the stepped roll coming into contact with the active material layer; and a second pressing step of, after the stepped roll pressing step, press-stretching the active material layer of the electrode sheet by roll-pressing.

### CROSS REFERENCE TO RELATED APPLICATIONS

The present application claims priority from Japanese Patent Application No. 2024-086693 filed on May 28, 2024, which is incorporated by reference herein in its entirety.

### BACKGROUND

The present invention relates to an electrode sheet manufacturing apparatus, a method of manufacturing an electrode sheet, and a method of manufacturing a battery.

JP 2023-036089 A discloses a method of manufacturing an electrode sheet including a coated portion, in which an active material layer containing an electrode material is coated on a metal foil, and an uncoated portion defined at an end portion of the coated portion. The manufacturing method disclosed in the publication discloses that the uncoated portion is pressed by a pair of elastic rolls when roll-pressing the electrode sheet. By pressing the uncoated portion using the pair of elastic rolls, compressive force and deformation force can be applied to the same location in the uncoated portion. It is stated that this allows the uncoated portion to be stretched while preventing breakage of the uncoated portion.

### SUMMARY

The present inventors found that there is an event that wrinkles may occur in the electrode sheet even though the uncoated portion is pressed with a pair of elastic rolls when roll-pressing the electrode sheet.

According to the present disclosure, an electrode sheet manufacturing apparatus is provided that manufactures an electrode sheet, which includes a current collector made of an oblong metal foil, an unformed portion defined along a longitudinal axis of the current collector at a predetermined widthwise position in the current collector, and an active material layer formed on a portion of the current collector other than the unformed portion. The electrode sheet manufacturing apparatus includes a roll-press unit that roll-presses the electrode sheet. The roll-press unit includes a conveyor device conveying the electrode sheet along a predetermined conveyance passage, a first pressing device disposed in the conveyance passage and press-stretching the unformed portion of the electrode sheet by a rubber roll, a stepped roll pressing device disposed in the conveyance passage and pressing a stepped roll onto the electrode sheet, and a second pressing device disposed downstream of the stepped roll pressing device in the conveyance passage and press-stretching the active material layer of the electrode sheet by roll-pressing. The stepped roll includes a stepped portion at a part coming into contact with a boundary region of the unformed portion with the active material layer, and the part coming into contact with the unformed portion has a larger diameter than other parts of the stepped roll coming into contact with the active material layer.

Such an electrode sheet manufacturing apparatus is able to reduce wrinkles of the electrode sheet that result from the difference in elongation rate of the current collector between the boundary region of the unformed portion with the active material layer and other regions of the unformed portion.

According to the present disclosure, a method of manufacturing an electrode sheet is provided that includes: a first pressing step of press-stretching the unformed portion of the electrode sheet by a rubber roll while conveying the electrode sheet along a predetermined conveyance passage; a stepped roll pressing step of, after the first pressing step, conveying the electrode sheet while pressing the electrode sheet onto a stepped roll including a stepped portion at a part of the stepped roll coming into contact with a boundary region of the unformed portion with the active material layer, the part coming into contact with the unformed portion having a larger diameter than other parts of the stepped roll coming into contact with the active material layer; and a second pressing step of, after the stepped roll pressing step, press-stretching the active material layer of the electrode sheet by roll-pressing.

Such a electrode sheet manufacturing method is able to provide an electrode sheet that reduces wrinkles resulting from the difference in elongation rate of the current collector between the boundary region and other regions of the unformed portion. It is also possible that the electrode sheet manufacturing method may be applied to a method of manufacturing a battery.

### BRIEF DESCRIPTION OF THE DRAWINGS

FIG. 1 is a manufacturing flowchart illustrating an electrode sheet manufacturing method.

FIG. 2 is a schematic view of an electrode sheet 10.

FIG. 3 is a schematic view illustrating another embodiment the electrode sheet 10.

FIG. 4 is a schematic view illustrating an example of a roll-pressing step S6 proposed herein.

FIG. 5 is a schematic view illustrating a first pressing step S6a.

FIG. 6 is a schematic view illustrating a stepped roll pressing step S6c.

### DETAILED DESCRIPTION

Hereinbelow, embodiments of the technology according to the present disclosure will be described with reference to the drawings. It should be noted, however, that the embodiments disclosed herein are, of course, not intended to limit the invention. The drawings are depicted schematically and do not necessarily accurately depict actual objects. The features and components that exhibit the same effects are designated by the same reference symbols as appropriate, and the description thereof will not be repeated as appropriate. Unless specifically stated otherwise, the recitation of numerical ranges in the present description, such as “X to Y”, is meant to include any values between the upper limits and the lower limits, inclusive, that is, “greater than or equal to X to less than or equal to Y”.

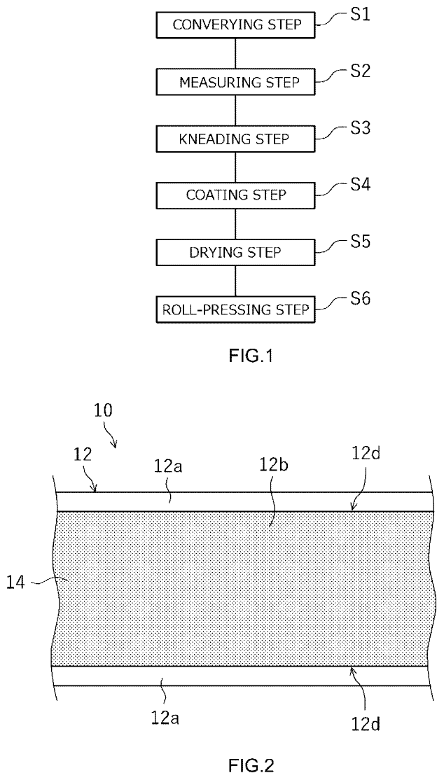

FIG. 1 is a manufacturing flowchart illustrating an electrode sheet manufacturing method. As illustrated in FIG. 1, the electrode sheet manufacturing method includes a conveying step S1, a measuring step S2, a kneading step S3, a coating step S4, a drying step S5, and a roll-pressing step S6. However, the electrode sheet manufacturing method may include other steps.

### Electrode Sheet 10

FIG. 2 is a schematic view of an electrode sheet 10. The electrode sheet 10 constitutes a positive electrode sheet or a negative electrode sheet of an electrode assembly that is to be accommodated in the inside of the electricity storage device. The term “electricity storage device” refers to a repeatedly chargeable device, and it is intended to encompass what is called storage batteries (chemical cells), such as lithium-ion secondary batteries, nickel-metal hydride batteries, and nickel-cadmium batteries, as well as capacitors (i.e., physical cells) such as electric double-layer capacitors.

As illustrated in FIG. 2, the electrode sheet 10 includes a current collector 12 and an active material layer 14. The current collector 12 is a member that is made of a metal foil. The current collector 12 is an oblong strip-shaped metal member. For the current collector 12, it is possible to use a metal material that has required electrical conductivity. For positive electrode current collector foil, it is possible to use, for example, aluminum, aluminum alloys, or the like. For negative electrode current collector foil, it is possible to use, for example, copper, copper alloys, or the like. The active material layer 14 is coated on a predetermined position within the current collector 12. The active material layer 14 is formed on at least one surface of the strip-shaped current collector 12. In this embodiment, the active material layer 14 is formed on both surfaces of the current collector 12. The active material layer 14 is a layer containing an electrode active material. For positive electrode active material, it is possible to use, for example, lithium-transition metal composite oxides. For negative electrode active material, it is possible to use, for example, carbon materials, silicon based materials, and composite oxides thereof. The active material layer may also contain additive agents other than the electrode active material, such as binders and conductive agents.

The electrode sheet 10 is formed by coating an electrode mixture slurry, which forms the active material layer 14, onto the current collector 12, and drying. The current collector 12 is provided with uncoated portions 12a (i.e., unformed portions) and a coated portion 12b. The uncoated portions 12a are portions of the current collector 12 on which the active material layer 14 is not coated. The uncoated portions 12a are defined along a longitudinal axis of the electrode sheet 10 in widthwise end portions of the electrode sheet 10. In this embodiment, the uncoated portions 12a are defined at both widthwise ends of the electrode sheet 10. The coated portion 12b is disposed between the uncoated portions 12a at both ends of the electrode sheet 10. The electrode mixture slurry is coated onto the coated portion 12b. As a result, the active material layer 14 is formed on the coated portion 12b of the current collector 12. That is, the active material layer 14 is disposed between the uncoated portions 12a at both widthwise ends of the electrode sheet 10. Thus, the electrode sheet may include the current collector 12 made of an oblong metal foil, unformed portions (uncoated portions 12a herein) defined along the longitudinal axis of the current collector 12 at predetermined widthwise positions in the current collector 12, and the active material layer 14 formed on a portion of the current collector 12 other than the unformed portions.

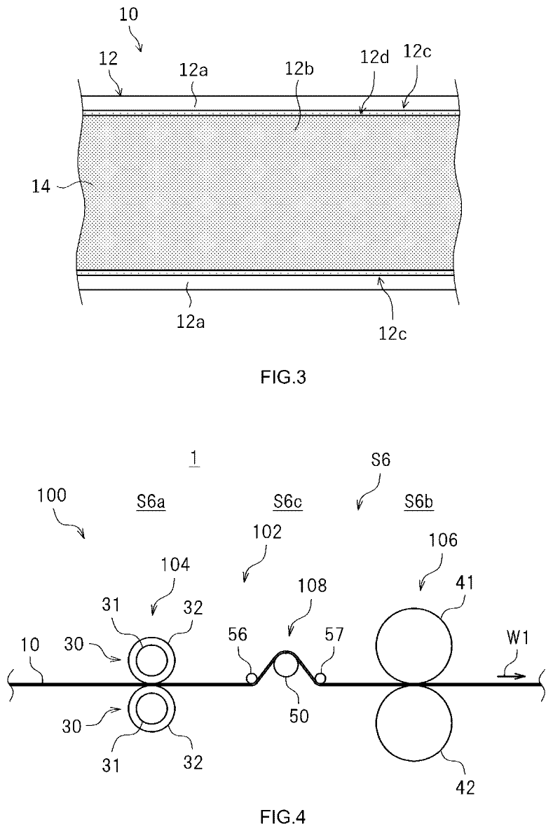

FIG. 3 is a schematic view illustrating another embodiment the electrode sheet 10. As illustrated in FIG. 3, the electrode sheet 10 may be provided with an insulative protective layer 12c at a position in each uncoated portion 12a that is adjacent to the coated portion 12b. Such a structure may be employed in, for example, an electrode sheet 10 used for positive electrode. Providing the protective layer 12c on the electrode sheet 10 used for positive electrode can prevent short circuits between the positive electrode current collector foil and the negative electrode active material layer. Such a protective layer 12c contains an insulative inorganic filler. Examples of the inorganic filler include insulating particles, for example, ceramic particles, such as alumina. The protective layer 12c may contain a binder, for example. The binder may be the same as those illustrated as can be contained in the positive electrode active material layer. In the following, FIGS. 2 and 3 are referred to as appropriate for the constituent components of the electrode sheet 10, even when not specifically stated so.

### Conveying Step S1, Measuring Step S2, Kneading Step S3, Coating Step S4, Drying Step S5

In the conveying step S1 shown in FIG. 1, the electrode sheet 10 is conveyed. The conveying step S1 involves conveying the electrode sheet 10 along a predetermined conveyance passage W1. The measuring step S2 involves weighing source materials for the active material layer 14 (see FIG. 2). The weighing may be implemented with a weighing device (not shown) that includes, for example, a balance scale, a load cell, or the like. The weighed source materials for the active material layer 14 are mixed in the kneading step S3. The kneading step S3 may be implemented by a kneading device (not shown). The source materials for the active material layer 14 that have been made into a slurry state by the kneading device are coated onto the current collector 12 (see FIG. 2) in the coating step S4. The coating step S4 may be implemented by, for example, a coating device (not shown), such as a slit coater, a gravure coater, a die-coater, or a comma coater. The drying step S5 involves drying the slurry-state source materials for the active material layer 14 that have been coated. The drying step S5 may be implemented by, for example, a dryer device (not shown) that generates hot air or emits infrared rays.

### Roll-Pressing Step S6

The roll-pressing step S6 is a step of roll-pressing the electrode sheet 10. Herein, the substrate material for the electrode sheet 10 is a metal foil. The electrode sheet 10 includes a portion on which the active material layer 14 is formed (i.e., coated portion 12b) and a portion on which the active material layer 14 is not formed (i.e., uncoated portion 12a). The roll-pressing step S6 is mainly intended to adjust the active material layer 14 formed by coating to have an appropriate density.

In the roll-pressing step S6, the coated portion 12b is roll-pressed in order to allow the active material layer 14 to have an appropriate density. When the coated portion 12b is roll-pressed, the substrate material, the current collector 12 is stretched in the coated portion 12b. However, in the uncoated portions 12a, the pressing pressure is not directly transmitted to the current collector 12, so the current collector 12 is not easily stretched in the uncoated portions 12a. Accordingly, in the state in which the coated portion 12b alone is pressed, variations in elongation may occur between the coated portion 12b and the uncoated portions 12a. When variations in elongation are large between the coated portion 12b and the uncoated portions 12a, it may be a cause of wrinkles that form in the electrode sheet 10. The uncoated portions 12a are cut into predetermined shapes in a later processing step to form tabs. At that processing step, if wrinkles occur in the boundary regions 12d of the uncoated portions 12a with the active material layer 14, the tabs may not be formed into an appropriate shape.

In order to prevent the wrinkles from forming in the electrode sheet 10, the current collector 12 may be stretched in the uncoated portions 12a before or after roll-pressing the coated portion 12b. One technique of stretching the current collector 12 in the uncoated portions 12a is a technique of pressing the uncoated portions 12a by means of a rubber roll. The technique of pressing the uncoated portions 12a by means of a rubber roll may be referred to as EPS (Elasticity Powered Stretching) as appropriate. The device that presses the uncoated portions 12a by a rubber roll may be referred to as an EPS device as appropriate.

The present inventors found an event in which wrinkles may occur in the electrode sheet 10 even when the uncoated portions 12a are stretched by EPS before or after roll-pressing. The wrinkles occur particularly at the boundary regions 12d of the uncoated portions 12a with the active material layer 14. The present inventors have discovered that such an event is caused because, when stretching the uncoated portions 12a by EPS, the boundary regions 12d of the uncoated portions 12a with the active material layer 14 cannot be stretched appropriately.

That is, the active material layer 14 is formed on the coated portion 12b. The active material layer 14 is a layer containing metal oxide, such as lithium-transition metal composite oxide. Pressing a rubber roll of the EPS onto the active material layer 14 may be a cause of peeling of the active material layer 14. From such a viewpoint, the position of the rubber roll is set in the EPS so that the rubber roll does not come into contact with the coated portion 12b. As a consequence, with EPS, it is difficult to stretch the boundary between the uncoated portions 12a and the coated portion 12b as well as the adjacent areas thereto. In addition, a protective layer containing an inorganic filler is in some cases formed on the boundary between the uncoated portions 12a and the coated portion 12b. In cases where the protective layer is formed, the elongation rate may not match between the area in which the protective layer is formed and the area in which the protective layer is not formed when the rubber roll of EPS is pressed thereon.

As described above, when the uncoated portions 12a are stretched by EPS, it is difficult to appropriately stretch the boundary regions 12d of the uncoated portions 12a with the active material layer 14. As a consequence, the present inventors believe that strain remains in the boundary regions 12d, causing wrinkles in the electrode sheet.

FIG. 4 is a schematic view illustrating an example of a roll-pressing step S6 proposed herein. As illustrated in FIG. 4, the roll-pressing step S6 includes a first pressing step S6a, a second pressing step S6b, and a stepped roll pressing step S6c.

The first pressing step S6a is the above-mentioned EPS, a step of stretching the uncoated portions 12a of the electrode sheet 10. FIG. 5 is a schematic view illustrating a first pressing step S6a. As illustrated in FIG. 5, the first pressing step Soa is a step of press-stretching the uncoated portions 12a of the electrode sheet 10 with a pair of rubber rolls 30 while conveying the electrode sheet 10 along a predetermined conveyance passage.

As illustrated in FIG. 5, the rubber rolls 30 may each be a roll member in which an elastic material 32 is disposed on a shaft 31. The elastic material 32 used for the rubber rolls 30 may be an elastic material having a required Young's modulus. Examples of the elastic material 32 include resins, such as rubber and urethane. In the first pressing step S6a, the uncoated portions 12a are pressed by the rubber rolls 30, so that the portions that are pushed by the rolls are pressed and stretched by receiving the reaction force of the elastic deformation and compressive deformation from the rubber rolls 30. The first pressing step S6a is able to stretch the uncoated portions 12a without applying a high tension to the electrode sheet 10.

As illustrated in FIG. 4, the second pressing step Sob is a step of roll-pressing the active material layer 14 (coated portion 12b) of the electrode sheet 10. Such a step is a step of adjusting the active material layer 14 (coated portion 12b) to a required density. In the second pressing step S6b, as illustrated in FIG. 4, the electrode sheet 10 is sandwiched by a pair of rolls 41 and 42, and the active material layer 14 is compressed. In this step, the current collector 12, the substrate material, is press-stretched in the portion in which the active material layer 14 is formed (i.e., in the coated portion 12b).

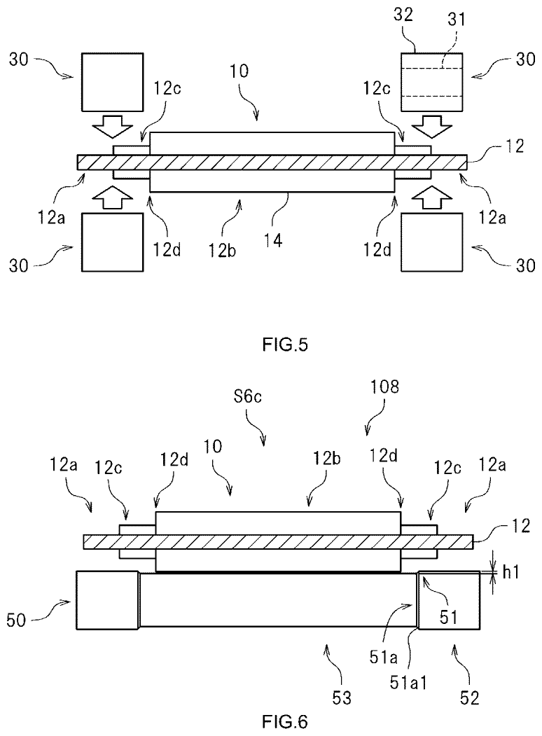

The stepped roll pressing step S6c is a step of locally stretching the current collector 12, the substrate material, in the boundary regions 12d (see FIGS. 2 and 3) of the uncoated portions 12a with the active material layer 14. FIG. 6 is a schematic view illustrating a stepped roll pressing step S6c.

### Stepped Roll 50

As illustrated in FIG. 6, a stepped roll 50 used in the above-described step S6c includes stepped portions 51a at parts 51 that come into contact with boundary regions 12d of the uncoated portions 12a with the active material layer 14. In addition, parts 52 that come into contact with the uncoated portions 12a have a larger diameter than that of a part 53 that comes into contact with the active material layer 14. In the embodiment shown in FIG. 6, the parts 52 that come into contact with the uncoated portions 12a have a unform diameter. The part 53 that comes into contact with the active material layer 14 also has a uniform diameter.

Herein, the boundary regions 12d of the uncoated portions 12a with the active material layer 14 may each be a region at or near the boundary between the active material layer 14 and an uncoated portion 12a of the electrode sheet 10. The boundary region 12d between the active material layer 14 and the uncoated portion 12a is defined as a region in which the current collector 12, the substrate material, is difficult to be stretched in the first pressing step S6a of press-stretching the uncoated portion 12a and in the second pressing step S6b of roll-pressing the active material layer 14. The boundary region 12d between the active material layer 14 and the uncoated portion 12a may be determined according to the specification of the electrode sheet 10 and the manufacturing process thereof. The width of the boundary region 12d between the active material layer 14 and the uncoated portion 12a may be, for example, about 3 mm to about 7 mm (for example, about 5 mm). The boundary region 12d between the active material layer 14 and the uncoated portion 12a may be provided with the protective layer 12c formed thereon, as illustrated in FIG. 3.

The stepped portions 51a are provided at the parts 51 that come into contact with the boundary regions 12d of the uncoated portions 12a with the active material layer 14. In the embodiment shown in FIG. 6, the height of the stepped portions 51a is set to a dimension such that the boundary regions 12d of the uncoated portions 12a with the active material layer 14 come into contact with the stepped portions 51a and stretched when conveying the electrode sheet 10 with the electrode sheet 10 being wound around the stepped roll 50. From such a viewpoint, the height of the stepped portions 51a may depend on the specification of the electrode sheet 10 (for example, the thickness of the current collector 12, the thickness of the active material layer 14 in the coated portion 12b, and the like). In the case where the current collector 12 as the substrate material used for the electrode sheet 10 is, for example, an aluminum foil having a thickness of 12 μm, the tension applied to the electrode sheet 10 when conveying the electrode sheet 10 with the electrode sheet 10 being wound around the stepped portion 51a may be 80 N to 200 N, for example about 100 N.

Herein, the height h1 of the stepped portions 51a is defined as the radial distance from a portion of the stepped roll 50 that comes into contact with the coated portion 12b to a portion thereof that comes into contact with the uncoated portions 12a. The height h1 of the stepped portions 51a may be, for example, from 0.50 mm to 1.50 mm. Each of the stepped portions 51a is composed of an inclined surface 51al that is uniformly inclined with respect to the axial direction of the stepped roll 50. The inclination angle of the inclined surface 51al may be, for example, from 15 degrees to 45 degrees with respect to the axial direction of the stepped roll 50, preferably 30 degrees. In addition, the start point and the end point of the inclined surface 51al may be subjected to a rounded chamfering process, and may preferably be subjected to a rounding process such that R=0.5, for example.

### Method of Manufacturing Electrode Sheet

The method of manufacturing an electrode sheet 10 proposed herein is carried out, as illustrated in FIG. 4, in the following order: a first pressing step S6a, a stepped roll pressing step S6c, and a second pressing step S6b. According to the method of manufacturing an electrode sheet 10 proposed herein, the electrode sheet 10 is first stretched at the uncoated portions 12a by the first pressing step S6a. Thereafter, the current collector 12 is stretched by the stepped roll pressing step S6c at the boundary regions 12d of the uncoated portions 12a with the active material layer 14. Thereafter, the coated portion 12b is stretched by the second pressing step S6b. In this case, the electrode sheet 10 is stretched in a stepwise manner from its outer sides, from the uncoated portions 12a, then the boundary regions 12d of the uncoated portions 12a with the active material layer 14, and then the coated portion 12b. This reduces the wrinkles resulting from the difference in elongation rate of the current collector 12 between the boundary regions 12d of the uncoated portions 12a with the active material layer 14 and other portions 12a and 12b, reducing wrinkles in the electrode sheet 10 as a whole.

The first pressing step S6a may use an EPS device that presses the uncoated portions 12a by rubber rolls 30. In this case, the position and the pressing force of the rubber rolls 30 may be adjusted in the EPS device so that the uncoated portions 12a are pressed by the rubber rolls 30. In addition, the position of the electrode sheet 10 that is conveyed toward the EPS device may be adjusted so that the positions of the uncoated portions 12a are aligned with the rubber rolls 30 of the EPS device. In the stepped roll pressing step S6c, the position of the electrode sheet 10 may be adjusted relative to the stepped roll 50 so that the stepped portions 51a of the stepped roll 50 come into contact with the boundary regions 12d of the uncoated portions 12a with the active material layer 14. In this embodiment, the stepped roll 50 is thicker at the portions thereof that come into contact with the uncoated portions 12a. This allows the uncoated portions 12a that have already been stretched in the first pressing step S6a to be supported by the stepped roll 50 in the stepped roll pressing step S6c.

### Electrode Sheet Manufacturing Apparatus 1

As illustrated in FIG. 4, an electrode sheet manufacturing apparatus 1 that embodies such an electrode sheet manufacturing method includes a roll-press unit 100 that roll-presses a strip-shaped electrode sheet 10. The roll-press unit 100 includes a conveyor device 102, a first pressing device 104, a stepped roll pressing device 108, and a second pressing device 106.

### Conveyor Device 102

The conveyor device 102 is a device that conveys the electrode sheet 10 along a predetermined conveyance passage W1. Although the details thereof are omitted, the conveyor device 102 may be a device that conveys the electrode sheet 10 along the conveyance passage W1. Although not shown in the drawings, the conveyor device 102 may include a mechanism for feeding the electrode sheet 10 along the conveyance passage W1, guide rolls that send out the electrode sheet 10 along the conveyance passage W1, a tension adjusting mechanism that applies a required tension to the electrode sheet 10, a mechanism for taking up the electrode sheet 10 that has been conveyed along the conveyance passage W1, and so forth.

### First Pressing Device 104

The first pressing device 104 may employ an EPS device using the rubber rolls 30, as described above. In the EPS device, the position and the pressing force of the rubber rolls 30 may be adjusted so that the uncoated portions 12a are pressed by the rubber rolls 30. In addition, the electrode sheet manufacturing apparatus 1 may also include a position adjustment device (not shown) that adjusts the position of the electrode sheet 10 that is conveyed toward the EPS device so that the positions of the uncoated portions 12a are aligned with the rubber rolls 30 of the EPS device.

### Stepped Roll Pressing Device 108

The stepped roll pressing device 108 is a device that is disposed in the conveyance passage W and presses a stepped roll 50 onto the electrode sheet 10. A specific example of the shape of the stepped roll 50 is as described above. In the stepped roll pressing device 108, as illustrated in FIG. 6, the stepped portions 51a are provided so as to match the boundary regions 12d of the uncoated portions 12a with the active material layer 14. In addition, the diameter of the parts 52 that come into contact with the uncoated portions 12a is larger than the diameter of the part 53 that comes into contact with the active material layer 14. With the stepped roll pressing device 108, the electrode sheet 10 is conveyed with its position being adjusted so that the positions of the boundary regions 12d of the uncoated portions 12a with the active material layer 14 are aligned relative to the stepped portions 51a of the stepped roll 50. For this reason, a position adjustment device (not shown) that adjusts the position of the electrode sheet 10 may be provided before the stepped roll 50.

Thus, the stepped roll pressing device 108 allows the electrode sheet 10 to be conveyed while the parts 51 of the stepped roll 50 that are provided with the stepped portion s51a are being pressed onto the boundary regions 12d between the active material layer 14 and the uncoated portions 12a of the electrode sheet 10. Herein, the stepped roll pressing device 108 is disposed downstream of the first pressing device (first pressing step S6a) 104 that stretches the uncoated portions 12a. The electrode sheet 10 is stretched at uncoated portions 12a, and thereafter stretched at the boundary regions 12d of the uncoated portions 12a with the active material layer 14 by the stepped portions 51a of the stepped roll 50. In addition, the stepped roll 50 has a larger diameter at the parts 52 that come into contact with the uncoated portions 12a than the diameter of the part 53 that comes into contact with the active material layer 14.

Thus, while the uncoated portions 12a and the active material layer 14 that have already been stretched by the first pressing device 104 are supported by the stepped roll 50 appropriately, the boundary regions 12d of the uncoated portions 12a with the active material layer 14 are pressed onto the stepped portions 51a of the stepped roll 50 for correction. This allows the electrode sheet 10 to be unlikely to break when the electrode sheet 10 is pressed onto the stepped roll 50. Furthermore, after the boundary regions 12d of the uncoated portions 12a with the active material layer 14 are stretched by the stepped roll pressing device 108, the process of roll-pressing the coated portion 12b of the electrode sheet 10 (the second pressing step S6b) is carried out by the second pressing device 106. Thus, in the electrode sheet 10, the electrode sheet 10 is stretched in a stepwise manner sequentially from its widthwise outer sides in the following order: the uncoated portions 12a, then the boundary regions 12d of the uncoated portions 12a with the active material layer 14, and then the coated portion 12b. This allows the electrode sheet 10 as a whole to be unlikely to break or form wrinkles.

Herein, the process of stretching the uncoated portions 12a (the first pressing step S6a) may be, as described above, a process by EPS, for example. As described above, it is difficult for EPS to stretch the current collector 12 at the boundary regions 12d of the uncoated portions 12a with the active material layer 14. With the electrode sheet manufacturing method and the electrode sheet manufacturing apparatus 1 proposed herein, the current collector 12 is stretched by the stepped roll 50 at the boundary regions 12d of the uncoated portions 12a with the active material layer 14. This means that, in the second pressing step S6b, the coated portion 12b is roll-pressed with the boundary regions 12d between the uncoated portions 12a and the active material layer 14 having been stretched. In this case, wrinkles are unlikely to occur in the uncoated portions 12a and in the boundary regions 12d of the uncoated portions 12a with the active material layer 14, and as a result, wrinkles are reduced across the electrode sheet 10 as a whole.

Moreover, as illustrated in FIGS. 3 and 6, because the boundary regions 12d are stretched by being pressed onto the stepped portions 51a of the stepped roll 50, the boundary regions 12d are stretched appropriately even when the protective layer 12c is provided on the boundary regions 12d of the uncoated portions 12a with the active material layer 14.

Wrinkles are reduced in the electrode sheet 10 manufactured by such a method of manufacturing an electrode sheet as a whole. Such a method of manufacturing an electrode sheet may be used for manufacturing a battery.

Various embodiments of the invention have been described hereinabove according to the present disclosure. Unless specifically stated otherwise, the embodiments described herein do not limit the scope of the present invention. It should be noted that various other modifications and alterations may be possible in the embodiments of the invention disclosed herein. In addition, the features, structures, or steps described herein may be omitted as appropriate, or may be combined in any suitable combinations, unless specifically stated otherwise.

As has been described above, the present description contains the disclosure as set forth in the following items.

### Item 1:

An electrode sheet manufacturing apparatus for manufacturing an electrode sheet, the electrode sheet comprising a current collector made of an oblong metal foil, an unformed portion defined along a longitudinal axis of the current collector at a predetermined widthwise position in the current collector, and an active material layer formed on a portion of the current collector other than the unformed portion, the apparatus including:
a roll-press unit roll-pressing the electrode sheet, wherein:
the roll-press unit includes:
   a conveyor device conveying the electrode sheet along a predetermined conveyance passage;
   a first pressing device disposed in the conveyance passage and press-stretching the unformed portion of the electrode sheet by a rubber roll;
   a stepped roll pressing device disposed in the conveyance passage and pressing a stepped roll onto the electrode sheet; and
   a second pressing device disposed downstream of the stepped roll pressing device in the conveyance passage and press-stretching the active material layer of the electrode sheet by roll-pressing; and
the stepped roll includes a stepped portion at a part coming into contact with a boundary region of the unformed portion with the active material layer, the part coming into contact with the unformed portion having a larger diameter than other parts of the stepped roll coming into contact with the active material layer.

### Item 2:

The electrode sheet manufacturing apparatus according to item 1, wherein the electrode sheet includes a protective layer disposed along a boundary between the active material layer and the unformed portion.

### Item 3:

A method of manufacturing an electrode sheet, the electrode sheet including a current collector made of an oblong metal foil, an unformed portion defined along a longitudinal axis of the current collector at a predetermined widthwise position in the current collector, and an active material layer formed on a portion of the current collector other than the uncoated portion, the method including:
a first pressing step of press-stretching the unformed portion of the electrode sheet by a rubber roll while conveying the electrode sheet along a predetermined conveyance passage;
a stepped roll pressing step of, after the first pressing step, conveying the electrode sheet while pressing the electrode sheet onto a stepped roll including a stepped portion at a part of the stepped roll coming into contact with a boundary region of the unformed portion with the active material layer, the part coming into contact with the unformed portion having a larger diameter than other parts of the stepped roll coming into contact with the active material layer; and
a second pressing step of, after the stepped roll pressing step, press-stretching the active material layer of the electrode sheet by roll-pressing.

### Item 4:

The electrode sheet manufacturing method according to item 3, wherein the electrode sheet includes a protective layer formed along a boundary between the active material layer and the unformed portion.

### Item 5:

A method of manufacturing a battery, the method including a method according to item 3 or 4.

What is claimed is:

1. An electrode sheet manufacturing apparatus for manufacturing an electrode sheet, the electrode sheet comprising a current collector made of an oblong metal foil, an unformed portion defined along a longitudinal axis of the current collector at a predetermined widthwise position in the current collector, and an active material layer formed on a portion of the current collector other than the unformed portion, the apparatus comprising:
a roll-press unit roll-pressing the electrode sheet, wherein:
the roll-press unit includes:
a conveyor device conveying the electrode sheet along a predetermined conveyance passage;
a first pressing device disposed in the conveyance passage and press-stretching the unformed portion of the electrode sheet by a rubber roll;
a stepped roll pressing device disposed in the conveyance passage and pressing a stepped roll onto the electrode sheet; and
a second pressing device disposed downstream of the stepped roll pressing device in the conveyance passage and press-stretching the active material layer of the electrode sheet by roll-pressing; and
the stepped roll includes a stepped portion at a part coming into contact with a boundary region of the unformed portion with the active material layer, the part coming into contact with the unformed portion having a larger diameter than other parts of the stepped roll coming into contact with the active material layer.

2. The electrode sheet manufacturing apparatus according to claim 1, wherein the electrode sheet includes a protective layer disposed along a boundary between the active material layer and the unformed portion.

3. A method of manufacturing an electrode sheet, the electrode sheet including a current collector made of an oblong metal foil, an unformed portion defined along a longitudinal axis of the current collector at a predetermined widthwise position in the current collector, and an active material layer formed on a portion of the current collector other than the uncoated portion, the method comprising:
a first pressing step of press-stretching the unformed portion of the electrode sheet by a rubber roll while conveying the electrode sheet along a predetermined conveyance passage;
a stepped roll pressing step of, after the first pressing step, conveying the electrode sheet while pressing the electrode sheet onto a stepped roll including a stepped portion at a part of the stepped roll coming into contact with a boundary region of the unformed portion with the active material layer, the part coming into contact with the unformed portion having a larger diameter than other parts of the stepped roll coming into contact with the active material layer; and
a second pressing step of, after the stepped roll pressing step, press-stretching the active material layer of the electrode sheet by roll-pressing.

4. The electrode sheet manufacturing method according to claim 3, wherein the electrode sheet includes a protective layer formed along a boundary between the active material layer and the unformed portion.

5. A method of manufacturing a battery, the method comprising a method according to claim 3.

6. A method of manufacturing a battery, the method comprising a method according to claim 4.
